(19) United States
(12) Patent Application Publication
(10) Pub. No.: US 2023/0297430 A1
(43) Pub. Date: Sep. 21, 2023

(54) Machine-Learning Model Retargeting

(71) Applicant: Adobe Inc., San Jose, CA (US)

(72) Inventors: Moumita Sinha, Cupertino, CA (US); Anup Bandigadi Rao, San Jose, CA (US); Tung Thanh Mai, San Jose (US); Vijeth Lomada, San Francisco, CA (US); Margarita R. Savova, Jersey City, NJ (US); Sapthotharan Krishnan Nair, Santa Clara, CA (US); Harleen Sahni, Washington, DC (US)

(73) Assignee: Adobe Inc., San Jose, CA (US)

(21) Appl. No.: 17/696,148

(22) Filed: Mar. 16, 2022

(51) Int. Cl. G06F 9/50; G06K 9/62

(52) U.S. Cl. CPC G06F 9/5044; G06F 9/5077; G06K 9/6262; G06K 9/6257; G06N 20/00

(57) ABSTRACT

Machine-learning model retargeting techniques are described. In one example, training data is generated by extrapolating feedback data collected from entities. These techniques supports an ability to identify a wider range of thresholds and corresponding entities than those available in the feedback data. This also provides an opportunity to explore additional thresholds than those used in the past through extrapolating operations outside of a range used to define a segment, for which, the feedback data is captured. These techniques also support retargeting of a machine-learning model for a secondary label that is different than a primary label used to initially train the machine-learning model.

### BACKGROUND

Service provider systems are configured to make a variety of digital services available to client devices over a network. An example of this is implementation of “the cloud” in which hardware and software resources of the service provider system are provided for access over a network to various entities to perform desired computational tasks. Examples of digital services include productivity services (e.g., to edit digital documents, digital presentations, and spreadsheets), content creation services (e.g., to create digital images, digital audio, digital video, and other digital media), social network services, content streaming and storage services, hosting services, and so forth.

To do so, a vast infrastructure of devices and software are used by the service provider system to implement these digital services. This infrastructure utilizes hardware such as servers, network connection devices, storage devices, firewalls, and so on to provide an executable service platform that employs virtual machines, load balancers, and other virtualized hardware to implement the digital services. As such, a wide range of hardware devices and software is utilized in real world scenarios to implement a vast range of digital services by service provider systems and client device that access those systems.

Conventional techniques used to manage operation of the service provider systems, however, are challenged by this variety. For example, techniques have been developed in which machine-learning models are trained as a classifier to generate probabilities in relation to a “label,” e.g., a class. Probabilities are generated defining whether entities are to be assigned a label, for which, the machine-learning model is trained. The label, for instance, is defined to generate probabilities of whether an event will or will not occur for a particular entity. This is usable to generate a likelihood that operation of a particular device will fail in a particular timeframe by training a machine-learning model using usage data that describes device operation. As a result, the machine-learning model is employed to gain insight into probabilities that events will occur before those events actually occur in order to manage operation of the devices.

Conventional techniques used to train the machine-learning model, however, to assign labels consume significant amounts of computational resources and training data, and as such, take hours and even days to perform. Thus, use of these machine-learning models in conventional scenarios also involve a significant time commitment to define, refine, and train. Any changes typically involve retraining the machine-learning model from the beginning, e.g., for use with other entities, to address other types of event occurrences, and so forth. As such, conventional machine-learning model training techniques are inefficient, resource intensive, and hinder operation of computing devices that implement the training techniques.

### SUMMARY

Machine-learning model retargeting techniques are described. In one example, a machine-learning model is utilized to perform a search. The machine-learning model is trained using training data that is generated by extrapolating feedback data collected from a segment of entities. These techniques supports an ability to identify a wider range of thresholds and corresponding entities than those available in the feedback data. This also provides an opportunity to explore additional thresholds than those used in the past through extrapolating operations outside of a range used to define the segment, for which, the feedback data is captured. These techniques also support retargeting of a machine-learning model for a secondary label that is different than a primary label used to initially train the model.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium machine-learning model training environment in an example implementation that is operable to perform machine-learning model retargeting to support search, e.g., as a classifier.

FIG. 2 depicts a system in an example implementation showing operation of a segment search module of FIG. 1 in greater detail as generating a search result that is used to define membership in a base segment for a primary label.

FIG. 3 depicts a system in an example implementation showing generation of an expanded segment based on a user input specifying an accuracy measure through interaction with a base accuracy/reach graph.

FIG. 4 depicts an example implementation in which a user input is received through interaction with the base accuracy/reach graph to define an expanded segment.

FIG. 5 is a flow diagram depicting a procedure in an example implementation of expanded segment generation.

FIG. 6 depicts a system in an example implementation of collecting feedback data that pertains to operation of an expanded segment of FIG. 3 that is used as a basis to retarget a machine-learning model.

FIG. 7 depicts an example implementation of display of feedback data generated based on the expanded segment.

FIG. 8 depicts a system in an example implementation of extrapolating feedback data of FIG. 6 and generating a retargeted machine-learning model through use of a retargeting module.

FIG. 9 depicts an example graph depicting a distribution of entities across respective thresholds from an expanded segment.

FIG. 10 depicts an example of a distribution of entities across respective thresholds and expansion of a range of observations from feedback data using extrapolation.

FIG. 11 depicts a system depicting generation of a retargeted segment using a retargeted accuracy-reach graph.

FIG. 12 is a flow diagram depicting a procedure in an example implementation of machine-learning model retargeting.

FIG. 13 illustrates an example system including various components of an example device that can be implemented as any type of computing device as described and/or utilize with reference to FIGS. 1-12 to implement embodiments of the techniques described herein.

### DETAILED DESCRIPTION

### Overview

Conventional techniques used to train machine-learning models as classifiers consume significant amounts of computational resources, consume significant amounts of time to complete training, and so forth. As such, these limitations challenge use in scenarios that involve repeated development and refinement of the machine-learning models to achieve a desired result.

Consider an example in which an engineer is tasked with identifying network devices used by a service provider system that are likely to fail. A machine-learning model trained as a classifier is configured to assign a label to a corresponding entity. In this scenario, the classifier is trained to determine probabilities that respective devices will fail within a particular timeframe. Thus, the entity corresponds to a hardware device and the event involves operation of the hardware device. This can be used for a wide range of search scenarios, such as locate data storage devices that are likely to reach capacity, network communications devices that experience less than a particular threshold amount of data, operational failure of a processor (e.g., as part of survival analysis), a software crash, and so forth.

This is typically performed for a respective segment that defines a subpopulation of entities to increase accuracy in this determination. Criteria that is usable to determine likely failure of a network connection device can be quite different than criteria usable to determine likely failure of a storage device. Thus, segments are employed to increase accuracy of these determined probabilities, especially when involving operation of different types of devices, software, and so forth.

However, training of the machine-learning model in conventional techniques typically consumes hours and even days to perform. Machine-learning models in conventional classifier scenarios are typically trained for a single label, e.g., “class.” Therefore, in conventional scenarios any changes to this label cause the engineer to start over “from scratch” to identify a new label, identify a segment, repeat the training, and then finally use the machine-learning model. This causes inefficient consumption of network resources, use of vast quantities of data, and involves significant amounts of time to proceed through these stages by the engineer and search system in order to achieve a desired result.

Accordingly, machine-learning model retargeting techniques for search are described that overcome conventional challenges and inefficiencies. As such, these techniques improve operation and accuracy of computing devices used to train and use machine-learning models (e.g., as classifiers) in search. In the following techniques, machine-learning models are trained as classifiers that utilize accuracy measures (e.g., precision, recall) at varying thresholds to predict probabilities of assignment of entities to corresponding labels, for which, the classifier is trained. This is used to define corresponding segments of a population in order to manage operation of entities included within that population and continued use of the machine-learning model is usable to adjust membership within the segment. A search system, for instance, employs a classifier to determine probabilities of whether an event will or will not occur for a particular entity, and thus whether the entity is to be assigned that “label,” or is a member of that “class.” This supports an ability to identify and manage operation of the service provider system regarding these entities.

In one example, the service provider system supports an ability to specify accuracies over a wide range of thresholds using corresponding accuracy measures of precision or recall in order to generate a segment. The engineer, for instance, specifies an accuracy measure through interaction with an accuracy/reach graph generated for a base segment to define criteria for membership in an expanded segment. The expanded segment is then usable to identify entities that “belong to” that expanded segment and manage operation of those entities. Precision and recall have a complimentary relationship in that as one increases the other decreases.

In order to generate the accuracy/reach graph, a machine-learning model is trained using usage data that corresponds to the entities in the base segment. The usage data is obtained from a data lake that is configured as a centralized collection of data describing operation of entities as part of the service provider system. The machine-learning model, once trained in this example, is configured to identify probabilities of the hardware (i.e., entities) of experiencing the event.

A base accuracy/reach graph is then generated as describing accuracy and reach using search results from the base machine-learning model. Accuracy indicates similarity of respective entities in the base segment, i.e., accuracy with respect to an underlying definition of membership criteria the base segment which are the probabilities generated by the machine-learning model in this example. Reach describes a corresponding number of the entities having that similarity, i.e., a size of a subpopulation.

A user input is then received by the search system via interaction with the user interface to generate an expanded segment by specifying an accuracy measure using the base accuracy/reach graph, e.g., 80% accuracy. The accuracy measure is used to form an expanded segment, which is then used by the search provider system to manage operation of corresponding entities.

Challenges arise, however, when accuracy measures are solely available for a limited range of threshold values. Continuing with the above example, feedback data is collected that includes usage data for the entities defined in the expanded segment. Because use of an expanded segment in real world scenarios is typically performed for a relatively high degree of similarity to a base segment from which the expanded segment is generated, the feedback data pertains to a limited range of observations for entities in that segment.

Accordingly, techniques are described that support machine-learning model retargeting. In these techniques, training data is generated by extrapolating feedback data collected from entities, e.g., from the expanded segment. These techniques support an ability to identify a wider range of thresholds and corresponding entities than those available in the feedback data. This also provides engineers with an opportunity to explore additional thresholds than those used in the past through extrapolating operations “outside” of a range used to define the expanded segment. These techniques also support retargeting of a machine-learning model for a secondary label that is different than a primary label, for which, the machine-learning model was trained.

Continuing with the above example, feedback data is collected by a search system that pertains to the expanded segment. This feedback data, however, includes observations within a range of thresholds based on the accuracy measure accuracy measure that is used to define the expanded segment, e.g., from eighty percent to one hundred percent as described above. Accordingly, the search system employs data extrapolation techniques to expand these observations to support an ability to explore use of other accuracy measures and thresholds. The data extrapolation techniques, for instance, generate extrapolated data by processing the feedback data using cubic splines. This causes generation of observations “outside” of the range of thresholds defined for the expanded segment. As a result, further segments of the population may be explored, which is not possible using conventional techniques.

The machine-learning model retargeting techniques also support an ability to retarget a machine-learning model trained for a primary label for use with a secondary label. Following the above example, an engineer interacts with a base accuracy/reach graph generated for a base segment (e.g., using a base machine-learning model) to specify an accuracy measure to define an expanded segment. The base segment specifies entities as managed network connection devices and a primary label is an event involving operation of those devices, e.g., of experiencing an operational failure. A user input is received, via interaction with the graph, defining an accuracy measure to include additional entities that are not included in the base segment, e.g., by specifying eighty percent accuracy. This expanded segment is then used to manage operation of entities that are “members” of this segment, i.e., are at least eighty percent similar to include other types of network connection devices regarding the primary label.

Feedback data is collected by the search system for those entities. The engineer, however, is then interested in this example in determining event occurrence that involves a secondary label, e.g., of experiencing a network connection failure. In response, the search system utilizes the training data (which may be extrapolated as described above from the feedback data) to train a retargeted machine-learning model for the secondary label. The retargeted machine-learning model is then used to process usage data for the plurality of entities as search results indicating probabilities involving the secondary label. These search results are then used to generate a retargeted accuracy/reach graph. This graph supports a notion of which accuracy measure (e.g., threshold) to select a retargeted segment that pertains to this secondary label. Similar techniques to those described above are then usable to leverage the retargeted segment, e.g., to define membership and subsequent operation of entities, control membership to the segment using the model, and so on. In this way, the retargeted machine-learning model is trained with increased efficiency by leveraging the feedback data, even for use with a different label than that which was originally used to train the model. Further discussion of these and other techniques is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

Digital Medium Example Environment

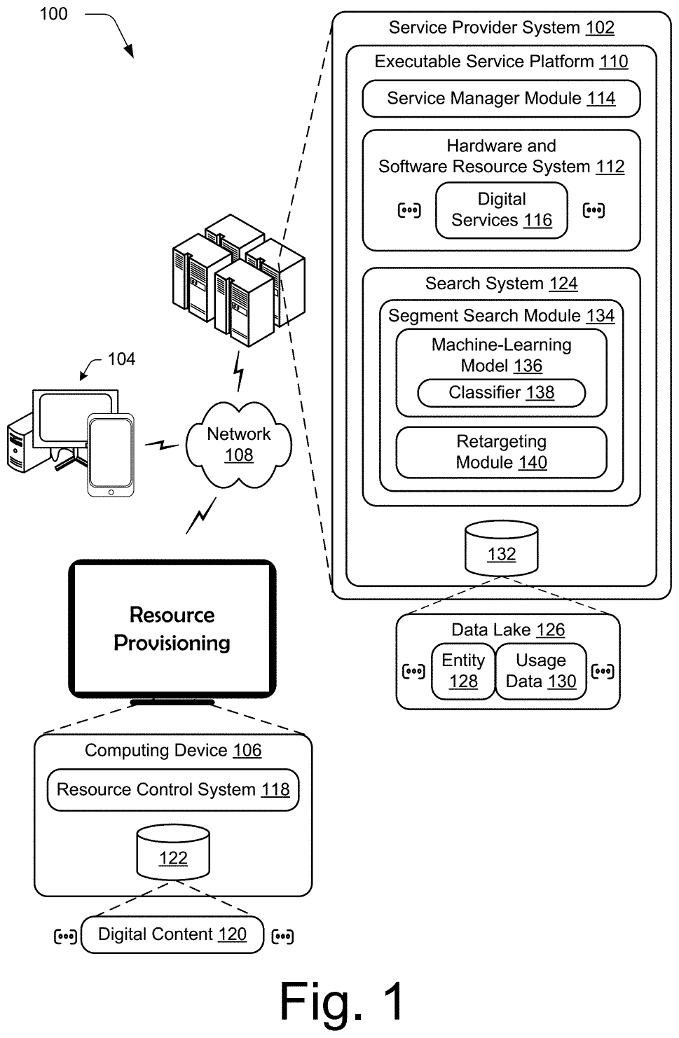

FIG. 1 is an illustration of a digital medium machine-learning model training environment 100 in an example implementation that is operable to perform machine-learning model retargeting to support search, e.g., as a classifier. The illustrated environment 100 includes a service provider system 102, client devices 104, and a computing device 106 that are communicatively coupled, one to another, via a network 108. Computing devices that implement the service provider system 102, client devices 104, and computing device 106 are configurable in a variety of ways.

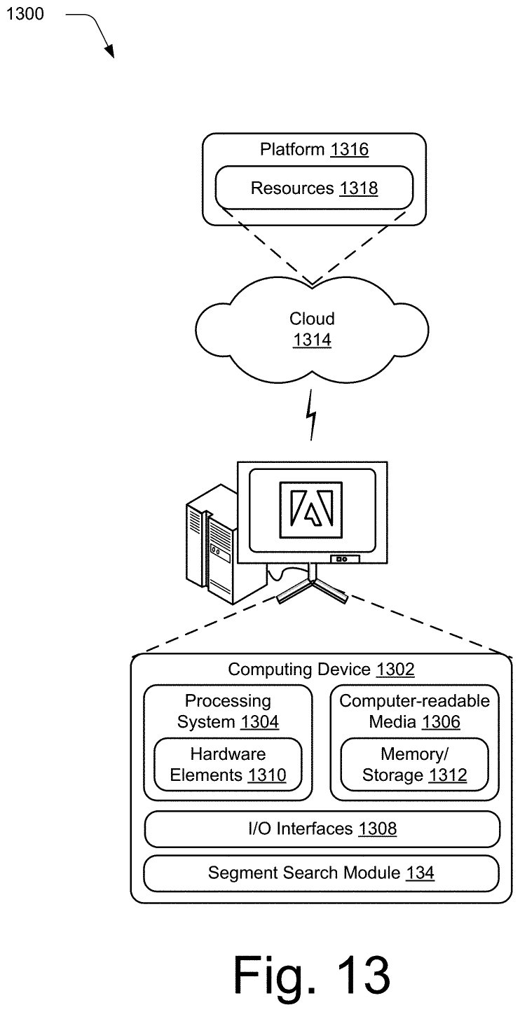

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, a computing device is also representative of a plurality of different devices, such as multiple servers utilized by a business to perform operations “over the cloud” as illustrated for the service provider system 102 and as described in FIG. 13.

The service provider system 102 includes an executable service platform 110 having a hardware and software resource system 112. The executable service platform 110 employs a service manager module 114 to manage implementation and access to digital services 116 “in the cloud” that are accessible by the client devices 104 via the network 108. Thus, the hardware and software resource system 112 provides an underlying infrastructure to support execution of digital services 116.

The executable service platform 110 supports numerous computational and technical advantages, including an ability of the service provider system 102 to readily scale resources to address consumption by the client devices 104. Thus, instead of incurring an expense of purchasing and maintaining proprietary computer equipment for performing certain computational tasks, cloud computing provides the client devices 104 with access to a wide range of hardware and software resources so long as the client devices 104 has access to the network 108.

The computing device 106, for instance, includes a resource control system 118 to control which digital services 116 are made available to the client devices 104, e.g., as a customer of the service provider system 102. Examples of digital services 116 include productivity services (e.g., to edit digital documents and spreadsheets), content creation services (e.g., to create digital images, digital audio, digital media), social network services, content streaming services, and so forth. Thus, the resource control system 118 in this example is configured to control which digital services 116 are accessible by the client devices 104 via the network 108. The resource control system 118, for instance, is usable to control communication of digital content 120 (illustrated as stored in a storage device 122) to respective client devices 104 via the network 108 through execution of the digital services 116.

As part of managing operation of the hardware and software resource system 112, the service provider system 102 includes a search system 124. The search system 124 is configured to search a data lake 126. The data lake 126 is implemented as a centralized repository of data describing operation of the executable service platform 110 of the service provider system 102. As part of this, the data lake 126 maintains an association of entities 128 and usage data 130 corresponding to those entities, e.g., in one or more storage devices 132.

The entities 128 are configurable to describe a variety of different aspects of operation of the executable service platform 110. The entities 128, in one example, correspond to hardware devices utilized to implement the hardware and software resource system 112, such as processors, memory devices, network communication devices, hardware firewalls, input/output devices, cooling devices, and so forth. The entities 128 also refer to software resources executed by the executable service platform 110, e.g., virtual servers, containers, applications, digital content 120, and so forth. The entities 128 are further configurable to manage access to the digital services 116, e.g., by referencing user accounts of the service provider system 102, individual client devices 104, and so on.

Thus, the data lake 126 includes a vast amount of data describing a variety of aspects of operation of the executable service platform 110. Because of this, however, search techniques used to search data from the data lake 126 that is to serve as a basis to manage operation of the executable service platform 110 are confronted with and often confounded by this vast amount of data. To address this, the search system 124 includes a segment search module 134 that is usable to interact with portions of this data defined using segments and train a machine-learning model 136 to predict a likelihood (i.e., probability) of event occurrence for those entities. The events, for instance, are configurable to describe aspects of hardware device operation described above, access to digital content 120, and other functionality made available via the digital services 116.

In the illustrated example, the machine-learning model 136 is implemented as a classifier 138. Classifiers are configured to assign probabilities of being assigned a particular label, for which, the machine-learning model 136 is trained, e.g., using supervised or unsupervised learning. For a classifier 138 employed in a spam filtering example, the classifier is configured to assign a probability that an email “is” or “is not” spam. In another example, the classifier is trained using digital images to determine whether a digital image includes or does not include a particular digital object.

Thus, the classifier 138, when used in conjunction with a segment, is utilized to determine probabilities of respective entities 128 in the segment as being assigned a label, which involves encountering an event in this example. As such, correct definition of the segment and labels have a direct effect on accuracy of achieving a desired result because the segment defines the subpopulation of entities defined in the data lake 126 that are used to train the model and the label defines a corresponding goal. Use of segments helps to address the vast amount of data included in the data lake 126. For example, the data lake 126 in some real-world scenarios includes Petabytes of data that describes billions of entities and corresponding usage data. As such, use of segments to describe a subpopulation of entities 128 in the data lake 126 is used to improve accuracy of machine-learning models 136 trained for that subpopulation to predict event occurrence (e.g., labels) for the subpopulation defined by the segment.

Conventional techniques used to train a machine-learning model 136, however, even when used for a particular segment of the entity population consume significant amounts of time, e.g., hours and even days in real-world scenarios. Therefore, these techniques are not available in scenarios involving short timeframes and are ponderous in scenarios involving refinement of a definition of the segment (i.e., to define entity membership in the segment) caused by repeated training of machine-learning models to achieve a desired result.

Accordingly, the segment search module 134 supports a retargeting module 140. The retargeting module 140 supports an ability to retarget a machine-learning model 136 configured as a classifier 138 from a primary label, for which, the model is trained to a secondary label.

The segment search module 134, for instance, is configured to support input of a base segment (i.e., a “seed” segment) and train the machine-learning model 136 for a primary label, e.g., occurrence of a particular event, based on usage data 130 corresponding to entities 128 that are members of the base segment. The machine-learning model 136, once trained, then processes usage data 130 corresponding to other entities to generate search results as similarities of these other entities in the base segment based on respective probabilities. A base accuracy/reach graph is formed by the segment search module 134 using the search results.

A user input is received that specifies an accuracy measure via the graph, which describes a range of thresholds defining accuracy (and thus also reach), and through use of the segment search module 134, identifies entities that are not included in the base segment, but are similar to this segment. The supports an ability to expand a search to a larger subpopulation of the entities 128 in the data lake 126. In this way, the segment search module 134 supports an ability to define segments and then retarget those segments over time, which is not possible in conventional techniques.

The retargeting module 140 is configured to support retargeting as part of search. In these techniques, the retargeting module 140 is configured to extrapolate feedback data collected from entities, e.g., from the expanded segment. These techniques support an ability to identify a wider range of thresholds and corresponding entities than those available in the feedback data. This also provides an opportunity to explore additional thresholds than those used in the past through extrapolating operations “outside” of a range used to define the expanded segment. These techniques also support retargeting of a machine-learning model for a secondary label that is different than a primary label, for which, the machine-learning model was trained. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

Expanded Segment Generation Using a Machine-Learning Model

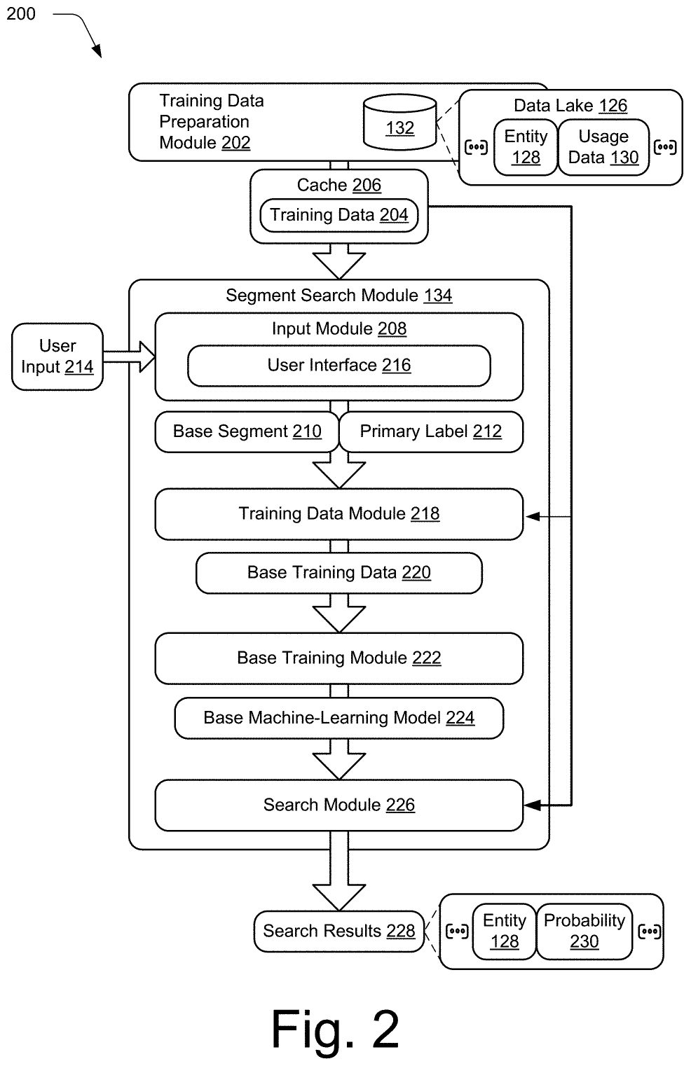

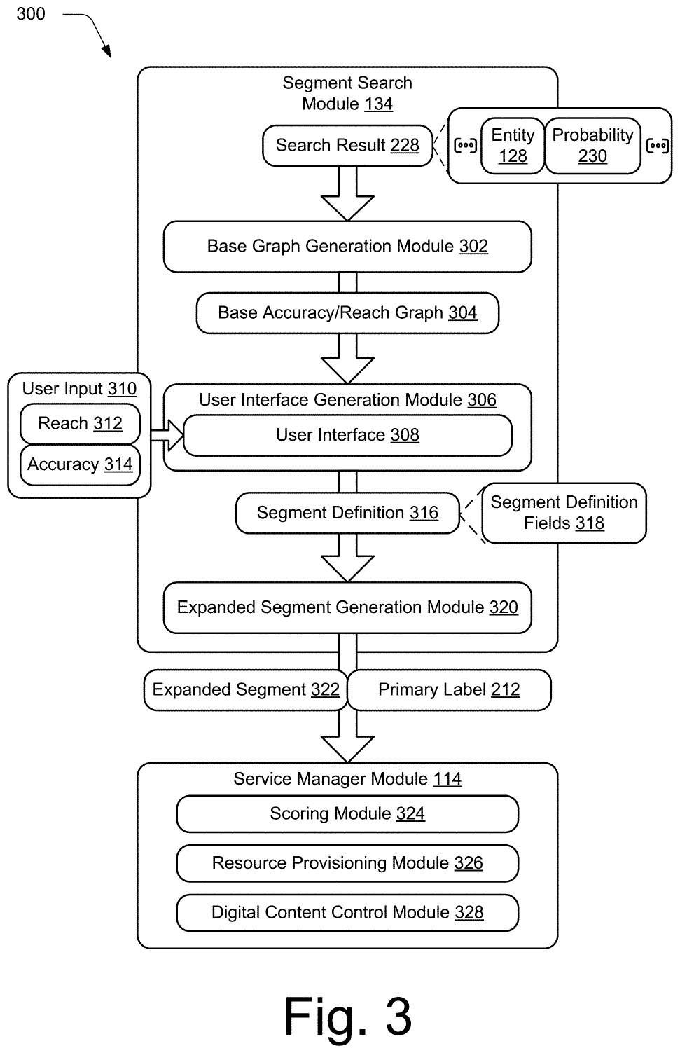

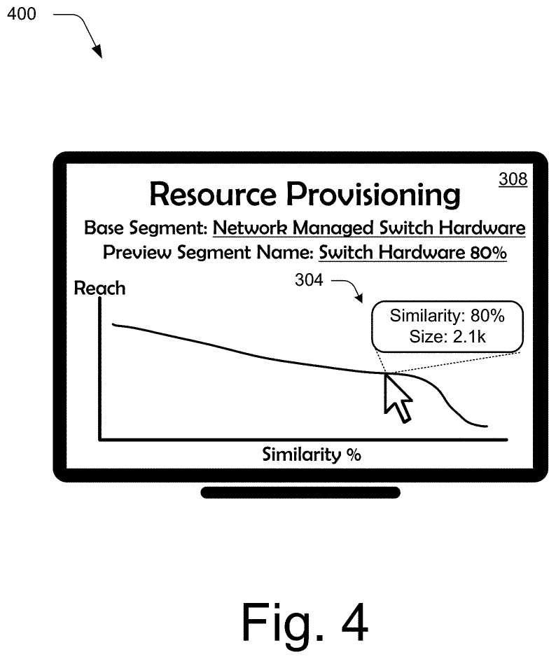

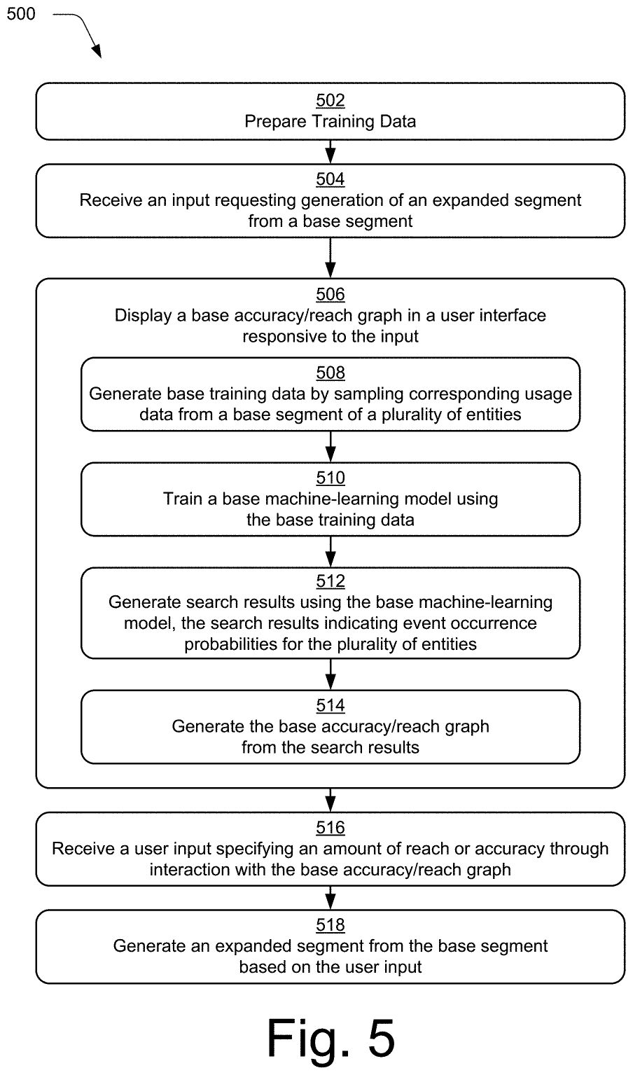

FIG. 2 depicts a system 200 in an example implementation showing operation of the segment search module 134 of FIG. 1 in greater detail as generating search results using a machine-learning model. FIG. 3 depicts a system 300 in an example implementation showing generation of an expanded segment based on a user input specifying an accuracy measure through interaction with a base accuracy/reach graph. FIG. 4 depicts an example implementation 400 in which a user input is received through interaction with the base accuracy/reach graph to define an expanded segment. FIG. 5 depicts a procedure 500 in an example implementation of expanded segment generation.

The following discussion describes techniques that are implementable utilizing the previously described systems and devices to perform machine-learning model training for search. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5.

As previously described, conventional techniques used to train classifiers and other types of machine-learning models consume significant amounts of computational resources. Further, challenges are encountered when subsequent changes are to be made to the model, e.g., to change a label of a classifier, which typically forces the training to “start over” in conventional scenarios. Accordingly, the segment search module 134 supports retargeting techniques to address data sparseness in feedback data received by the segment search module 134. These techniques also support an ability to retarget the machine-learning model 136 from a primary label, for which, the model is trained to a secondary label, e.g., using the feedback data. Accordingly, in this portion of the discussion generation of an expanded segment from a base segment is described, which is then used as a basis to perform retargeting in the subsequent section.

FIG. 2 depicts a system 200 in an example implementation showing operation of the segment search module 134 in greater detail as generating a search result that is used to define membership in a base segment for a primary label. In this example, a training data preparation module 202 is configured to prepare training data 204 (block 502) from data included in the data lake 126, e.g., for inclusion in a cache. Preparation of the training data 204 includes formation as part of a structured query language (SQL) database, filtering to remove data that is not relevant to model training (e.g., redundant data, superfluous data that does not differentiate operation of one entity from another, and so on), and use of an indexer to index the data based on entity 128 in the cache 206. The training data preparation module 202 is configured in some instances to perform this preparation offline for storage in the cache 206 to reduce an amount of time used subsequently to train machine-learning models.

An input module 208 is utilized to input a base segment 210 for a respective primary label 212. An engineer interacting with the resource control system 118 of the computing device 106, for instance, utilizes a collection of base segments as a basis for a variety of searches. In this example, the engineer decides that it is desirable to expand a subpopulation of entities beyond that of the base segment 210 and thus reconfigure how a corresponding search is performed, e.g., to locate these additional entities for management as part of the service provider system 102. Accordingly, a user input 214 is received that requests generation of an expanded segment from the base segment 210 (block 504). In response, a base accuracy/reach graph is displayed by the segment search module 134 in the user interface 216 responsive to the user input 214 (block 506) that is usable to define the expanded segment.

To do so, a training data module 218 is employed to generate base training data 220 by sampling training data 204 from the cache 206 that corresponds to the base segment 210 (block 508), and more particularly entities having membership in that segment. The sampling, for instance, is performed to take subsets of the training data 204 corresponding to entities defined for the base segment 210 from a plurality of entities 128 included in the data lake 126 (block 508). Through use of the training data 204 from the cache 206, this processing is performable in real time.

The base training data 220 is then used by a base training module 222 to train a base machine-learning model 224 (block 510) for the primary label 212. When training the base machine-learning model 22 as a classifier, for instance, the base training data 220 is sampled from usage data 130 describing characteristics of operation of respective entities, e.g., the network managed switch hardware. In this example, the primary label 212 describes whether events did or did not occur. The base training data 220 describes events and circumstances around the events that provide insight into what potentially caused and/or is an indicator of event occurrence for a respective entity 128.

The base machine-learning model 224, once trained, is then employed by the search module 226 to generate search results 228. The search results 228 indicates probabilities 230 of event occurrence for the plurality of entities 128 (block 512), respectively, for the primary label 212. The base machine-learning model 224, as previously described, when trained as a classifier is configured to determine probabilities of relating to the primary label 212. The primary label 212 pertains to event occurrence in this discussion. Continuing with the above example, the event describes whether a corresponding network managed switch hardware will experience operational failure in a given timeframe. The base machine-learning model 224, once trained using the training data 204, is then usable to process subsequent data from the cache 206 and/or usage data 130 for other entities outside of the base segment 210 to determine probabilities of event occurrence for those entities as defined within the search result 228.

FIG. 3 depicts a system 300 in an example implementation showing generation of an expanded segment based on a user input specifying an accuracy measure through interaction with a base accuracy/reach graph. The search result 228 is received by a base graph generation module 302 and used to generate a base accuracy/reach graph 304 (block 514). The base accuracy/reach graph 304 is then passed to a user interface generate module 306 as an input to generate a user interface 308 that includes the graph. A user input 310 is received that specifies an accuracy measure as an amount of reach 312 or accuracy 314 through interaction with the base accuracy/reach graph 304 (block 516).

FIG. 4 depicts an implementation 400 of the base accuracy/reach graph 304 as displayed in a user interface 308. The base accuracy/reach graph 304 includes a first axis defining respective amounts of reach and a second axis defining respective amounts of accuracy, i.e., “similarity.” The user input 310 is depicted as being input via a cursor control device (e.g., mouse) as selecting a particular point along the base accuracy/reach graph 304 as the accuracy measure by defining a respective threshold. This causes output of a popup menu indicating respective amounts of accuracy (e.g., “similarity: 80%”) and reach (e.g., “size: 2.1k”) of a subpopulation of the entities having that amount of similarity. Thus, in this example the measure of accuracy and selection of the respective threshold “80%” defines a range of thresholds, e.g., from 80% to 100%.

In response, a segment definition 316 is generated that includes segment definition fields 318 that define characteristics of the entities having the corresponding amount of similarity and/or are in the audience size having the corresponding reach as selected by the user input 310. This is used by an expanded segment generation module 320 to generate an expanded segment 322 from the base segment (block 518) for the primary label 212. The expanded segment 322 therefore defines a subpopulation of the entities 128 that includes at least one additional entity that is not a member the base segment 210.

The expanded segment 322 is then output by the segment search module 134 for use by a service manager module 114 in managing operation of the service provider system 102. Examples of functionality that implement this management are represented as a scoring module 324 that is configured to score results for individual entities, e.g., for accuracy in the search result 228 for an expanded machine-learning model that is trained using similar techniques above. A resource provisioning module 326 is usable to control operation of executable service platform 110 for hardware device operation (e.g., processors, memory devices, network connection devices), software entities (e.g., virtual servers, load balancers), and so forth that are “members” of the expanded segment. In another example, a digital content access control module 328 is used to control output of digital content 120 to entities identified in the expanded segment, e.g., access to, communication of, and so forth. The expanded segment is also used in this example as a basis to perform retargeting of a corresponding expanded machine-learning model, an example of which is described in the following section.

Machine-Learning Model Retargeting

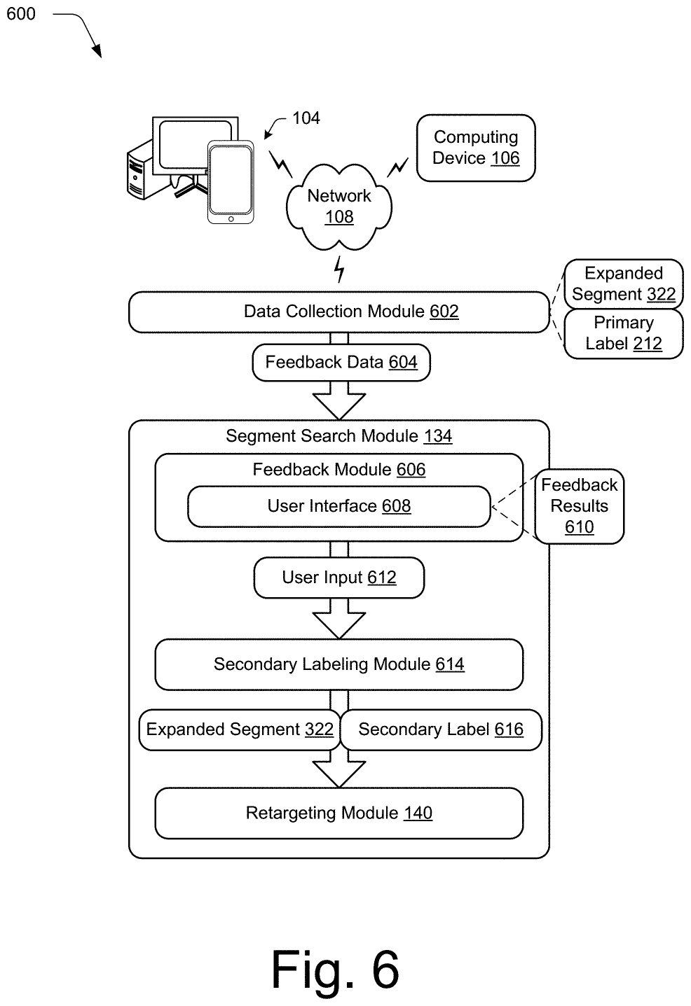

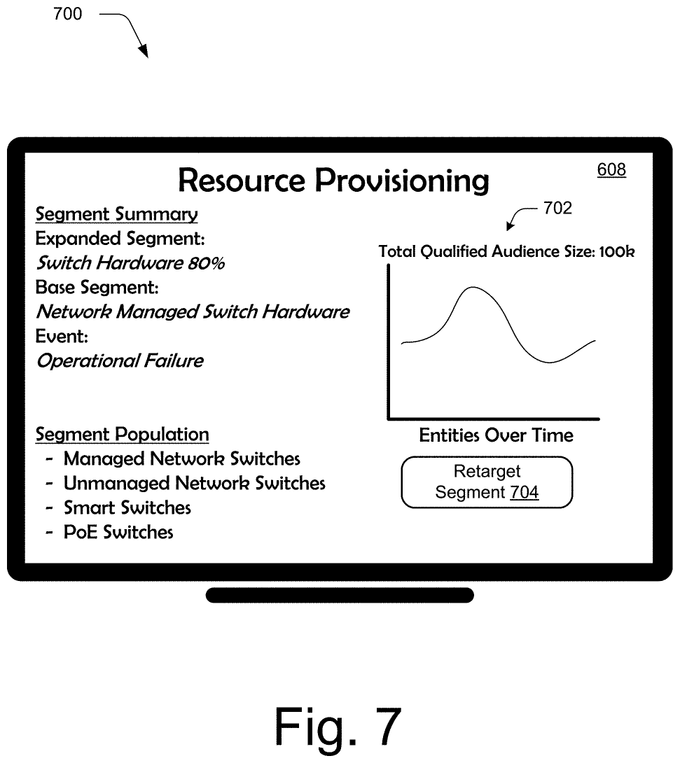

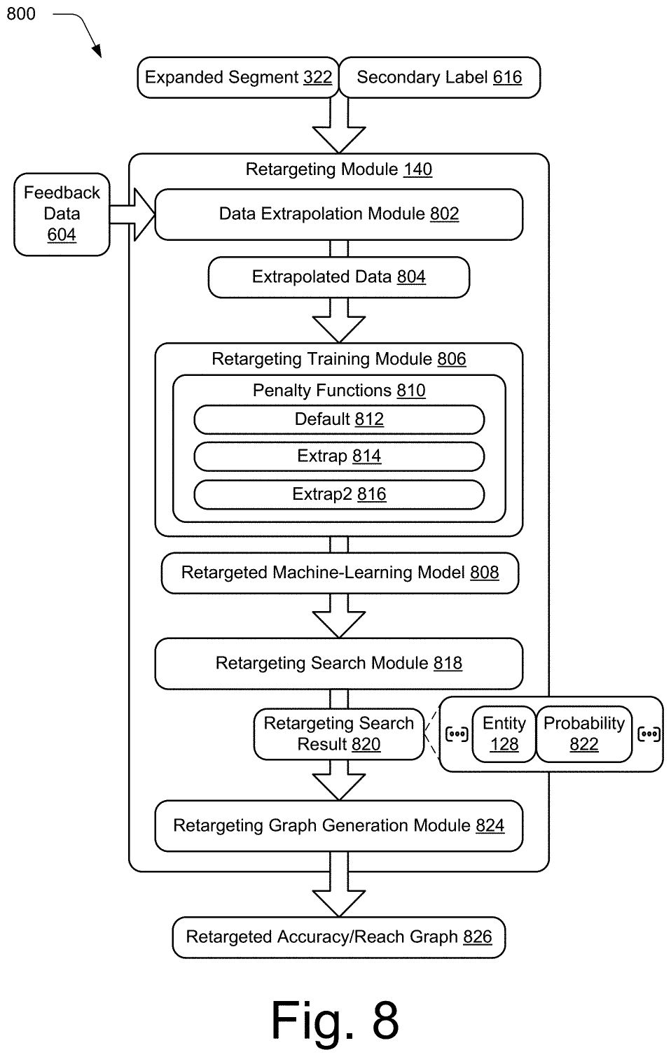

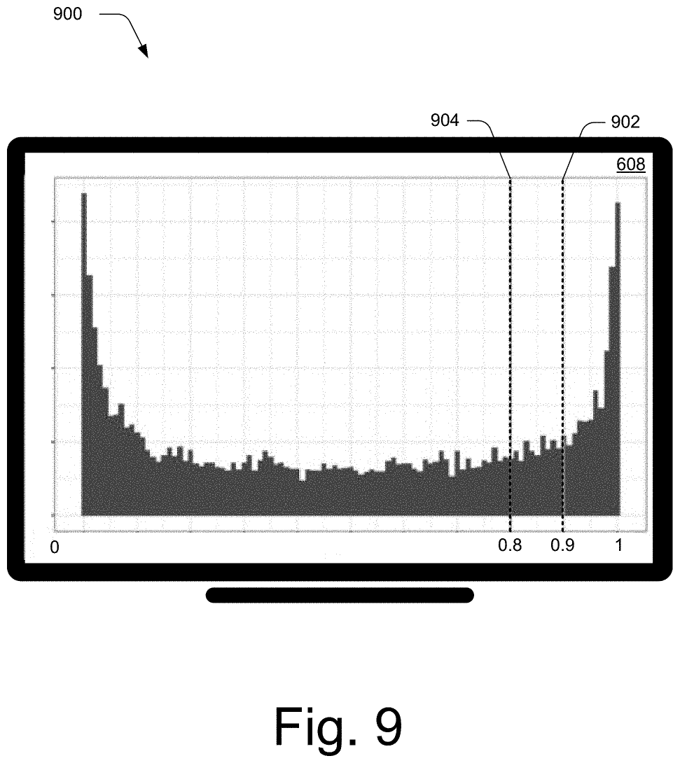

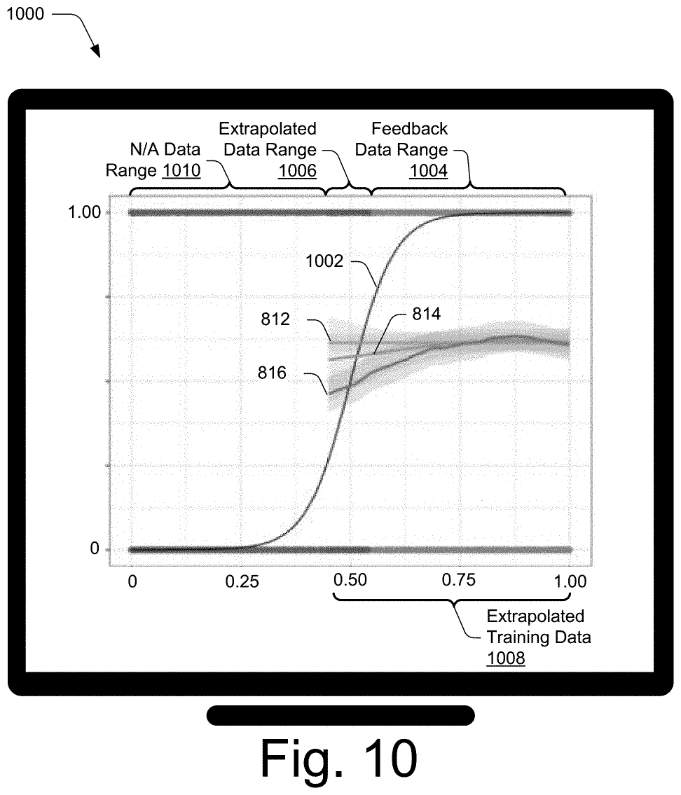

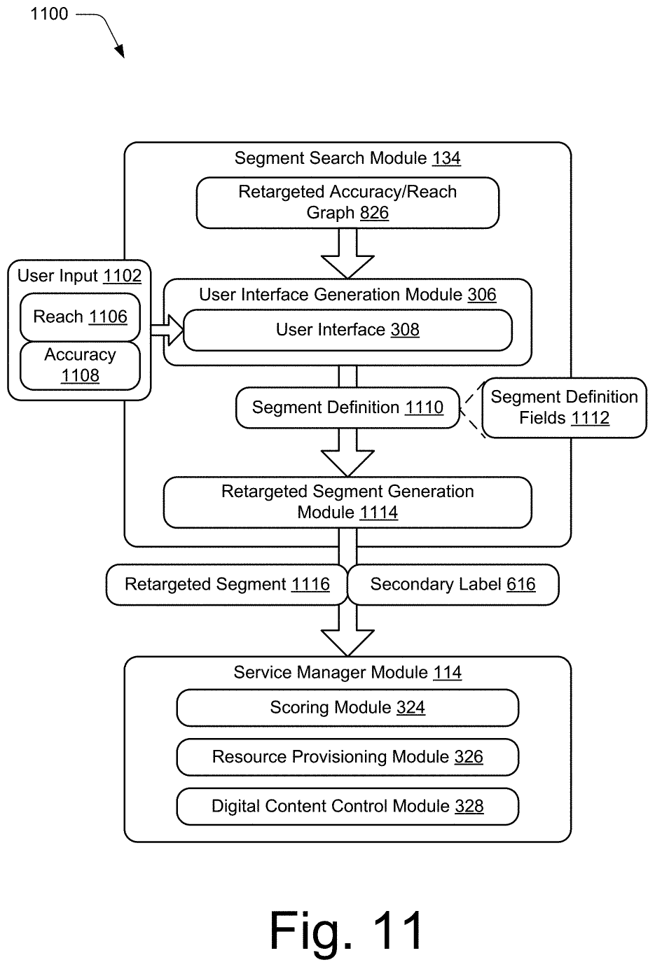

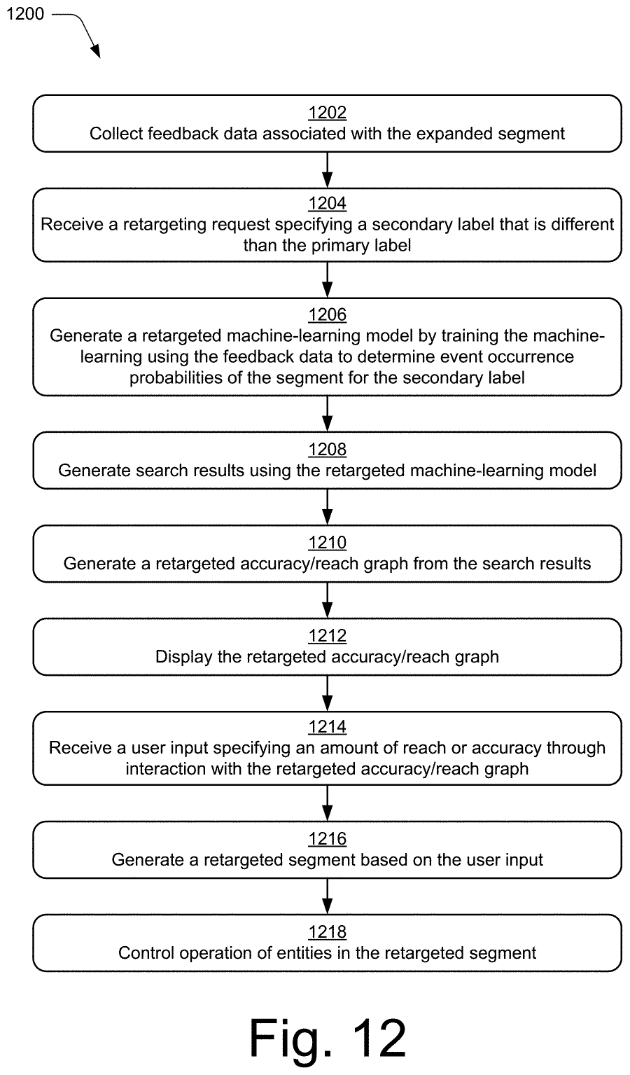

FIG. 6 depicts a system 600 in an example implementation of collecting feedback data that pertains to operation of an expanded segment of FIG. 3 that is used as a basis to retarget a machine-learning model. FIG. 7 depicts an example implementation 700 of display of feedback data generated based on the expanded segment. FIG. 8 depicts a system 800 in an example implementation of extrapolating feedback data of FIG. 6 and generating a retargeted machine-learning model through use of a retargeting module. FIG. 9 depicts an example graph 900 showing a distribution of entities across respective thresholds. FIG. 10 depicts an example of a distribution of entities across respective thresholds and expansion of a range of observations from feedback data using extrapolation. FIG. 11 depicts a system showing generation of a retargeted segment using a retargeted accuracy-reach graph. FIG. 12 is a flow diagram depicting a procedure 1200 in an example implementation of machine-learning model retargeting.

The following discussion describes techniques that are implementable utilizing the previously described systems and devices to perform machine-learning model training for search. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 6-12.

To begin in this example, a data collection module 602 is configured to collect feedback data 604 (block 1202) regarding operation of entities included in the expanded segment 322 regarding the primary label 212. The feedback data 604, for instance, is collectable from the client devices 104, the computing device 106 used to implement the resource control system 118, from the data lake 126, and so forth. From the example above, the feedback data 604 pertains to an expanded segment 322 associated with a primary label 212. As such, the feedback data 604 pertains to a range of thresholds defining a measure of accuracy with respect to the base segment 210, e.g., for “Switch Hardware 80%” with which a range of thresholds having 80% or greater accuracy/similarity. Thus, the feedback data 604 describes a reduced range of thresholds and respective entities with respect to the population of entities as a whole. An expanded machine-learning model, trained based on the expanded segment, is usable to control entity membership in the expanded segment and thus management of entities belonging to that segment as previously described.

The feedback data 604 is provided as an input to a feedback module 606. The feedback module 606 is configured to generate a user interface 608 including feedback results 610 generated from the feedback, e.g., an extended accuracy/reach graph, population size over time, and so forth.

FIG. 7 depicts an example implementation 700 of display of characteristics of expanded segment search results generated based on the expanded segment 322 by an expanded machine-learning model. The user interface 608 includes information describing the expanded segment 322, such as a segment name “Switch Hardware 80%,” identification of a base segment used to create the expanded segment (e.g., “Network Managed Switch Hardware”) and the corresponding event, e.g., “operational failure.”

The user interface 608 also includes information identifying an expanded set of entities that are members of the expanded segment 322. This includes entities included in the original base segment 210, e.g., the “managed network switch hardware.” Additional entities are also listed that are identified using the expanded segment 322, e.g., “unmanaged network switches,” “smart switches,” and “PoE switches.” The user interface 608 also includes a graph 702 showing changes in an audience size of entities that qualify for membership in the expanded segment 322 over time. In this way, the engineer in this example is provided with the expanded machine-learning model to evaluate search results generated based on a definition of the expanded segment 322.

A user input 612 is then received through interaction with the user interface 608 that includes a retargeting request specifying a secondary label that is different than a primary label 212, for which, the expanded machine-learning model is trained (block 1204). The user input 612, for instance, views the user interface 608, and from this, becomes interested in a secondary label (e.g., secondary goal), for which, the expanded machine-learning model was not trained, i.e., is different than the primary goal. In this above example, the primary label 212 is “operational failure,” whereas the secondary label 616 is “network connection failure.” The user input 612 is received responsive to selecting an option 704 to “retarget segment.” In response, a secondary labeling module 614 generates an expanded segment 322 and secondary label 616 that is to be used as a basis by a retargeting module 140 to perform retargeting of the expanded machine-learning model.

FIG. 8 depicts operation of the retargeting module 140 of FIG. 6 in greater detail as generating a retargeted machine-learning model by training using feedback data 604 to determine event occurrence probabilities of a segment for a secondary label (block 1206). To do so, the retargeting module 140 receives the feedback data 604 as an input that describe operation of entities included in the expanded segment. In the previous section, a base segment includes a subpopulation of entities. The expanded segment provides an expanded subpopulation, e.g., that are similar to entities in the base segment but are not included in the base segment as of yet. The use of the expanded segment supports an expanded search to locate these entities. In the previous example, the base segment includes network managed switch hardware. By specifying “80%” similarity through interaction with a base accuracy/reach graph, an expanded segment is then formed, which in this example includes addition entities such as unmanaged network switches, smart switches, PoE switches, and so on based on the threshold selected via the user interface. In this way, the base accuracy/reach graph supports an ability to locate additional entities based on associated labels, for which, a machine-learning model is trained.

FIG. 9 depicts an example graph 900 depicting a distribution of entities across respective thresholds from an expanded segment. A number of entities is depicted along the Y-axis at each threshold value of the expanded machine-learning model along the X-axis. Based on this, the engineer chooses an accuracy measure (e.g., between “0” and “1”) through interaction with the user interface 608 that also controls a size of the expanded subpopulation to be reached. For example, in order to reach a subpopulation with a measure of accuracy greater that ninety percent a user input 902 is received as selecting “0.9,” for a measure of accuracy greater than eighty percent a user input 904 is received selecting “0.8,” and so on. This results in a larger population size for retargeting but will include entities that are increasingly dissimilar with a definition of the segment as determined by the machine-learning model, e.g., has decreased respective probabilities. In the example above, a base segment for network managed hardware as experiencing operational failure was first defined. An expanded segment is then formed to expand a search for additional entities, e.g., that are at least eighty percent similar to the base segment as an expanded segment.

However, in real world scenarios accuracy measures are typically selected that have a relatively high amount of accuracy. As such, the feedback data 604 generated for these expanded segments has a limited range of thresholds, e.g., from eighty to one hundred percent. Therefore, conventional techniques are limited to estimation of thresholds within that range.

To overcome these challenges, the retargeting module 140 includes a data extrapolation module 802 that is configured to generate extrapolated data 804 from the feedback data 604. The extrapolated data 804 is configured to expand observations to permit an engineer to explore thresholds beyond those detailed in the feedback data.

FIG. 10 depicts an example 1000 of a threshold selection curve 1002 that expands a range of thresholds from the feedback data 604. The threshold selection curve 1002 is illustrated as part of a graph having an X-axis that defines accuracy values (e.g., from 0.0 to 1.) and a Y-Axis for reach. A feedback data range 1004 is illustrated in this example that defines observations for threshold values from 0.55 to 1.00 that are included in the feedback data 604. Through use of the data extrapolation module 802, observations are generated in an extrapolated data range 1006 having threshold values that are not included in the feedback data range 1004, and therefore are “outside” the actual observations received. The feedback data range 1004 and the extrapolated data range 1006 together from extrapolated data 1008 which is usable to explore values outside a range of observations in the feedback data range 1004. In this example, a “NA data range” 1010 is also illustrated that denotes a range of threshold values that are not extrapolated from the feedback data 604 nor are included in the extrapolated training data 1008. As illustrated, the data extrapolation module 802 supports an ability to “expand” beyond threshold values defined in the feedback data 604.

A variety of techniques are usable by the data extrapolation module 802 to generate the extrapolated data 804, an example of which includes cubic splines. For example, feedback data 604 is represented as “{(x1, y1),(x2, y2), . . . }.” Cubic splines are piecewise cubic polynomials. Given “K knots τ1≤τ2 . . . ≤τ_{K}∈R,” a cubic spline includes 4^{th} order polynomials “pi (a·X³+b·x²+c·x+d” where “a,” “b,” “c,” and “d” are constants in each of the intervals “[τᵢ, τᵢ₊₁].” At each of the knots “τ₁,” the two polynomials that meet “pᵢ₋₁” and “pᵢ” have the same 0^{th}, 1^{st}, and 2^{nd} order derivatives. Cubic splines are considered the lowest order splines for which discontinuity at the knots is not visible to the human eye. When “y” is binary, a Generalized Additive Model (GAM) model is expressed as “logit(E(y|x))=s(x). μ(x):=E(y|x)” is the conditional mean of the response, “s(x)” is a cubic spline and “logit(E(y|x))=log(μ(x)/(1−μ(x)))” is a logit link function.

The extrapolated data 804 is then passed from the data extrapolation module 802 as an input to a retargeting training module 806 to train a retargeted machine-learning model 808. Training is performed in this example by maximizing a penalized maximum likelihood estimator. In binary response case, this is expressed as:

max lkhood(s(x))−penalty(s(x))

in which:

(s(x))=Σᵢ(yᵢ log pᵢ+(1−yᵢ)log(1−pᵢ))

where:

pᵢ=(1+exp(−s(xᵢ))⁻¹

and

penalty(s(x))=λ·∫s″(x)²dx

As part of training, the retargeting training module 806 is configured to utilize a variety of different penalty functions 810, examples of which are illustrated as default 812, extrap 814, and extrap2 816 in FIGS. 8 and 10. The default 812 is a cubic spline with a second order penalty. The extrap 814 is a cubic spline with both a first order and a second order penalty. The penalty function extrap2 816 includes each of the three orders of derivatives. This last extrapolation performed by extrap2 816 has the lowest variance of the three as shown in FIG. 10. Thus, training of the retargeted machine-learning model 808 leverages the extrapolated data 804 both to extend the range of observations and also retarget the model from the primary label to the secondary label, i.e., to switch “goals.”

The retargeted machine-learning model 808 is then passed from the retargeting training module 806 to a retargeting search module 818. The retargeting search module 818, like the other search modules previously described, is configured to generate search results using the retargeted machine-learning model 808 (block 1208), but in this instance is performed for the secondary label 616. Retargeting search results 820, for instance, to specify probabilities 822 that respective entities from the data lake are to be assigned the secondary label.

In the above example, the primary label 212 pertains to an operational failure for a base segment 210 of network managed switch hardware, which was then used as a basis to form an expanded segment through interaction with the base accuracy/reach graph. This was used in FIG. 4 to specify eighty percent similarity to the base segment. Feedback data is collected as observations involving operation of the expanded segment is collected. The retargeting module 140 is then utilized to perform retargeting, which includes data extrapolation as well as retargeting of a machine-learning model for use with a secondary label 616, e.g., experiencing a network connection failure. The retargeting search result 820 is used by a retargeting graph generation module 824 to generate a retargeted accuracy/reach graph 826 (block 1210), which is then displayed in a user interface (block 1212).

FIG. 11 depicts an example 1100 of a system showing generation of a retargeted segment for a secondary label based on a user input specifying an accuracy measure through interaction with the retargeted accuracy/reach graph. The retargeted accuracy/reach graph 826 is passed to a user interface module 306 as previously described in relation to FIG. 3 as an input to generate a user interface 308 that includes the graph. A user input 1102 is received that specifies as accuracy measure as an amount of reach 1106 or accuracy 1108 through interaction with the retargeted accuracy/reach graph 826 (block 1214).

In response, a segment definition 1110 is generated that includes segment definition fields 1112 that define characteristics of the entities having the corresponding amount of similarity and/or are in the audience size having the corresponding reach as selected by the user input 1102. This is used by a retargeted segment generation module 1114 to generate a retargeted segment 1116 from the expanded segment (block 1216) for the secondary label 616 based on the user input 1102. The retargeted segment 1116 therefore defines a subpopulation of the entities 128 that includes at least one additional entity that is not a member the expanded segment 1116 and is performed for the secondary label 616. The retargeted segment 1116 is then usable to control operation of the entities (block 1218) using a service manager module 114 as previously described. In this way, the retargeting module 140 supports continued segment refinement, machine-learning model training, and retargeting of labels using feedback data collected for previous segments, thereby conserving computational resources by leveraging readily available data, which is not possible in conventional techniques.

Example System and Device

FIG. 13 illustrates an example system generally at 1300 that includes an example computing device 1302 that is representative of one or more computing systems and/or devices that implement the various techniques described herein. This is illustrated through inclusion of the segment search module 134. The computing device 1302 is configurable, for example, as a server of a service provider, a device associated with a client (e.g., a client device), an on-chip system, and/or any other suitable computing device or computing system.

The example computing device 1302 as illustrated includes a processing system 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1306 is illustrated as including memory/storage 1312. The memory/storage 1312 represents memory/storage capacity associated with one or more computer-readable media. The memory/storage 1312 includes volatile media (such as random access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing system 1304. The instructions and/or functions are executable/operable by one or more articles of manufacture (for example, one or more computing devices 1302 and/or processing systems 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to encountered demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium machine-learning model training environment, a method implemented by a computing device, the method comprising:
training, by the computing device, a machine-learning model for generating event occurrence probabilities for a primary label based on a segment of a plurality of entities;
displaying, by the computing device, an accuracy/reach graph generated for the primary label based on the event occurrence probabilities for the plurality of entities;
collecting, by the computing device, feedback data for the segment;
receiving, by the computing device, a retargeting request specifying a secondary label that is different than the primary label;
generating, by the computing device, a retargeted machine-learning model by training the machine-learning model using the feedback data to determine event occurrence probabilities of the segment for the secondary label; and
displaying, by the computing device, a retargeted accuracy/reach graph generated for event occurrence probabilities of the plurality of entities for the secondary label using the retargeted machine-learning model.

2. The method as described in claim 1, wherein the machine-learning model is a classifier.

3. The method as described in claim 1, wherein further comprising extrapolating the feedback data to form a graph including threshold beyond observed limit in the feedback data.

4. The method as described in claim 3, wherein the extrapolating is performed using cubic splines.

5. The method as described in claim 3, wherein the graph supports threshold selection beyond observed values in the feedback data.

6. The method as described in claim 1, wherein the training is performed by maximizing a penalized maximum likelihood estimator.

7. The method as described in claim 1, wherein the training is performed using a penalty function defined as a cubic spline with a second order penalty.

8. The method as described in claim 7, wherein the penalty function also includes a first order penalty.

9. The method as described in claim 1, wherein the entities are devices and further comprising identifying a retargeted segment using the retargeted machine-learning model and controlling operation of devices in the retargeted segment.

10. The method as described in claim 1, wherein the event occurrence probabilities involve device operation as part of an executable service platform of a service provider system.

11. The method as described in claim 1, further comprising controlling access to digital content for the plurality of entities based on a search result generated by the retargeted machine-learning model.

12. In a digital medium machine-learning model training environment, a method implemented by a computing device, the method comprising:
training, by the computing device, a machine-learning model as a classifier for generating event occurrence probabilities;
identifying, by the computing device, a segment of a plurality of entities using the machine-learning model, the segment defined using an accuracy measure defining a range of thresholds for results corresponding to the plurality of entities, respectively, from the machine-learning model;
extrapolating, by the computing device, feedback data collected for the segment into an expanded range of the thresholds that is greater than the range of thresholds defined for the segment;
generating, by the computing device, a retargeted machine-learning model by training the machine-learning model based on the extrapolated feedback data; and
displaying, by the computing device, a retargeted accuracy/reach graph generated for event occurrence probabilities of the plurality of entities using the retargeted machine-learning model.

13. The method as described in claim 12, wherein the extrapolating is performed using cubic splines.

14. The method as described in claim 12, wherein the segment is defined based on a user input through interaction with an accuracy/reach graph to specify the accuracy measure defining the range of thresholds, the feedback data includes observations within the range of thresholds, and the extrapolating expands the range of thresholds to form the expanded range of thresholds.

15. The method as described in claim 12, further comprising generating a retargeted segment responsive to a user input specifying a retargeted measure of accuracy through interaction with the retargeted accuracy/reach graph.

16. In a digital medium machine-learning model retargeting environment, a system comprising:
a base model training module implemented by a processor to train a base machine-learning model for generating event occurrence probabilities for a primary label based on a base segment of a plurality of entities;
a base graph generation module implemented by the processor to display a base accuracy/reach graph for the primary label based on event occurrence probabilities for the plurality of entities generated by the base machine-learning model;
an expanded segment generation module implemented by the processor to form an expanded segment from the plurality of entities responsive to a user input received through interaction with the base accuracy/reach graph;
a data collection module implemented by the processor to collect feedback data associated with the expanded segment of the entities for the primary label;
a retargeting module implemented by the processor to train a retargeted machine-learning model using the feedback data to determine event occurrence probabilities for a secondary label; and
a retargeting graph generation module implemented by the processor to generate a retargeted accuracy/reach graph based on event occurrence probabilities from the retargeting machine-learning model for the secondary label.

17. The system as described in claim 16, wherein the base machine-learning model and the retargeted machine-learning model are classifiers.

18. The system as described in claim 16, wherein the data collection module includes a data extrapolation module to extrapolate the feedback data.

19. The system as described in claim 18, wherein the data extrapolation module extrapolates the feedback data using cubic splines.

20. The system as described in claim 16, wherein the expanded segment is defined based on the user input through interaction with the base accuracy/reach graph to specify a threshold amount of accuracy, the feedback data includes observations within a range defined using the threshold amount of accuracy, and the data collection module expands the range as including at least one observation that is outside the range.
